(19) United States
(12) Patent Application Publication
(10) Pub. No.: US 2015/0178409 A1
(43) Pub. Date: Jun. 25, 2015

(54) ART SEARCH RESULTS

(71) Applicant: Microsoft Corporation, Redmond, WA (US)

(72) Inventors: Brian Kernan, Bellevue, WA (US); Mai Dang, Redmond, WA (US); Ajesh George, Redmond, WA (US)

(73) Assignee: Microsoft Corporation, Redmond, WA (US)

(21) Appl. No.: 14/138,098

(22) Filed: Dec. 22, 2013

(51) Int. Cl. G06F 17/30

(52) U.S. Cl. CPC G06F 17/30994; G06F 17/3028

(57) ABSTRACT

One or more techniques and/or systems are provided for populating an interactive map with art search results. For example, an art search query may be received (e.g., a user may submit a query “French Cubism”). A set of art search results, such as artwork, artists, galleries, geographical locations and/or other art search results, may be identified based upon the art search query. An interactive map may be populated with the set of art search results. For example, the interactive map may be populated with map pins representing galleries that display French Cubist artwork. Various task completion functionality may be supported, such as travel planning to a gallery, purchasing prints, reserving gallery tickets, sharing art search results through a social network, etc. In this way, the user may explore artwork and/or locations, such as galleries, that display such artwork.

### BACKGROUND

Many users utilize search interfaces (e.g., a search app, a search website, a social network, etc.) to discovery, explore, and/or interact with content. For example, a student writing a research paper on post-impressionist art may initially search for informational websites providing descriptions of post-impressionism. The student may continue their research by visiting museum websites to view examples of post-impressionist art. Finally, the student may research articles about post-impressionism. In this way, the student may explore various websites comprising textual descriptions, imagery, videos, and/or articles regarding post-impressionism.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for populating an interactive map with art search results are provided herein. For example, an art search query may be received (e.g., a user may submit an art period search query “Renaissance” through a search interface, such as a social network, a map app, a search engine website, a travel app, etc.). A set of art search results associated with the art search query may be identified (e.g., a client-side search interface and/or a server-side search server may query an art repository comprising a variety of art information related to artworks, artists, galleries, images, etc.). An interactive map may be populated with the set of art search results (e.g., map pins may represent locations of Renaissance art, such as art galleries displaying such Renaissance artwork). The interactive map may be displayed through an app (e.g., a map app) and/or a website (e.g., embedded into a search engine results page; displayed through a map website; etc.). Various functionality may be supported through the interactive map, such as an add to favorites functionality (e.g., the user may add artwork, an artist, an art gallery, an art period, and/or other art search results to a favorites list), tagging functionality (e.g., the user may tag artwork or a gallery with the user's opinion, which may be shared with other users), purchasing functionality (e.g., the user may order an art print), travel functionality (e.g., the user may be provided with information and/or functionality related to travel accommodations, such as flights, car rentals, hotels, restaurants, vacation packages, user reviews and/or other information for a particular gallery), etc.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of populating an interactive map with art search results.

FIG. 2A is a component block diagram illustrating an exemplary system for receiving an art search query.

FIG. 2B is a component block diagram illustrating an exemplary system for receiving an art search query.

FIG. 2C is a component block diagram illustrating an exemplary system for receiving an art search query.

FIG. 3 is a component block diagram illustrating an exemplary system for receiving an art search query.

FIG. 4 is a component block diagram illustrating an exemplary system for populating an interactive map with art search results.

FIG. 5 is a component block diagram illustrating an exemplary system for populating an interactive map with art search results.

FIG. 6 is a component block diagram illustrating an exemplary system for displaying an information interface comprising art information.

FIG. 7 is a component block diagram illustrating an exemplary system for facilitating visual navigation between artwork of a gallery.

FIG. 8 is a component block diagram illustrating an exemplary system for displaying an information interface comprising art information.

FIG. 9 is a component block diagram illustrating an exemplary system for embedding an interactive map, populated with a set of art search results, within a search engine results page.

FIG. 10 is an illustration of an exemplary computer readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for populating an interactive map with art search results are provided. For example, an interactive map may be populated with information relating to artwork, artists, galleries, and/or a variety of other information relating to an art search query submitted by a user. The user may explore various galleries populated within the interactive map. For example, the user may visually navigate between artwork on display at a gallery (e.g., responsive to receiving an art search query “Post-Impressionist art in New York”, Post-Impressionist artwork on display at galleries in New York may be displayed through the interactive map). In this way, the user may explore locational data and/or detailed information about specific works of art, styles of art, where to view art, and/or perform various functionality such as planning a trip to a gallery or purchasing a print.

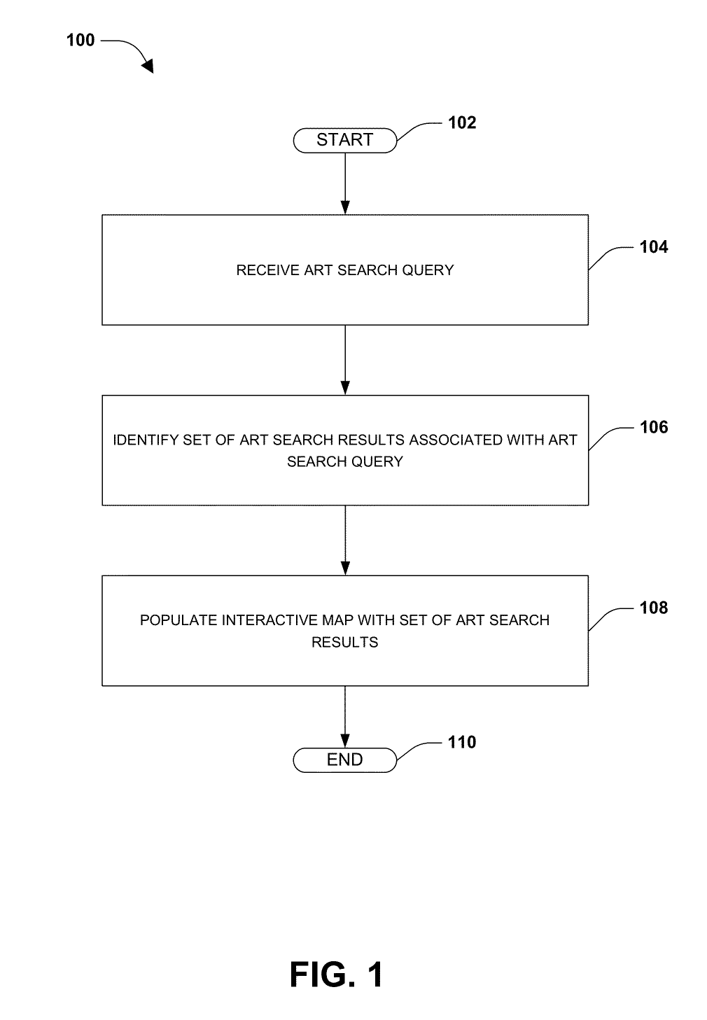

An embodiment of populating an interactive map with art search results is illustrated by an exemplary method 100 of FIG. 1. At 102, the method starts. At 104, an art search query may be received. For example, the art search query may be received through an operating system search interface (e.g., a search charm), an entity summary interface (e.g., a descriptive information interface, such as a hero interface, for an entity such as an artist), a search website, a social network search interface, a map app, a travel app, an art app, and/or other website or app. The art search query may comprises an artist name, a gallery name (e.g., MoMA) an art style, an artwork name, an artist nationality, an art type, a geographical location (e.g., city, state, country), an art period, a century, a tag (e.g., the user may search for art tagged by “Greek Mythology”), and/or a variety of other query categories or combinations thereof (e.g., “Monet” in “France” having a tag “Water Lilies”).

At 106, a set of art search results associated with the art search query may be identified. In an example, search functionality on a client device may be configured to identify the set of art search results (e.g., a search app may query an art information database hosted on the client device or may remotely access a search service configured to identify search results, such as art search results). In another example, the art search query may be submitted to a search service (e.g., a search engine server hosting a search engine website) that may remotely process the art search query to identify the set of art search results (e.g., and then provide the search results back to the client device. In this way, the set of art search results, such as artists, galleries, artwork, images, textual descriptions, articles, and/or a variety of other information relating to the art search query, may be identified.

At 108, an interactive map may be populated with the set of art search results (e.g., the search app may locally populate the interactive map; the search engine server may generate the interactive map, and may push the interactive map to the client device, such as through the search engine website or for display through an app hosted on the client device). For example, user interface elements, such as map pins, may be used to represent geographical locations of art search results (e.g., a map pin may represent an art gallery in France that has one or more pieces of artwork by Monet). In an example, the interactive map may be displayed through an app, a website, a search engine results page, a mobile alert, an operating system search interface (e.g., a search charm), and/or any other website or app. The user may explore the interactive map to view art search results by navigating around the interactive map (e.g., panning input, zooming input, etc.). The user may explore art search results by interacting with art search results. For example, responsive to a user selecting a map pin representing a gallery, art search results associated with the gallery may be presented as an information interface. The information interface may be populated with art information associated with an art search result associated with the gallery (e.g., an art interface for the art search result may be populated within the information interface). The art information may comprise an image of the gallery, an image of artwork, an image of an artist, a gallery description of the gallery, an art style, an art type, an art period, a century, a tag (e.g., a descriptive user tag for the artwork), geographical information for the gallery, an artist description, and/or a wide variety of other information associated with the art search result. In an example, the information interface may be populated with a plurality of art interfaces corresponding to artwork maintained by the gallery. Visual navigation between the art interfaces may be facilitated (e.g., a user may “flip through” the artwork utilizing touch gestures and/or navigational input interfaces). In this way, the user may view detailed information about the art search results and/or visually navigate between the art search results.

In an example of facilitating user navigation of the interactive map and/or art search results, an art search result interface associated with the interactive map (e.g., a sidebar, a menu interface, and/or any other interface) may be populated based upon the set of art search results. For example, the set of art search results may be organized based upon a hierarchical ordering of organization art categories to create a hierarchical set of art search results (e.g., a first organization art category corresponding to galleries, a second organization art category corresponding to dates, a third organization art category corresponding to art type such as paintings or sculptures, a fourth organization art category corresponding to art style such Modernism or Cubism, and/or other organization art categories). The art search result interface may be populated with the hierarchical set of art search result, such as according to a hierarchical tree structure. For example, a first level of the hierarchical tree structure may be populated with galleries corresponding to the first organization art category (e.g., a Gallery (A), a Gallery (B), a Gallery (C), etc.). Art search results may be displayed according to date as a second level of the hierarchical tree structure (e.g., artwork of Gallery (A) may be organized according to dates, artwork of Gallery (B) may be organized according to dates, etc.). Levels of the hierarchical tree structure may be visually collapsed or expanded. For example, the user may have an interest in artwork of Gallery (C), which may be expanded to show artwork of Gallery (C) organized according to dates (e.g., Gallery (A) and Gallery (B) may be collapsed).

Various interactivity and/or functionality may be facilitated for the set of art search results. In an example, responsive to receiving a tag input associated with an art search result, the art search result may be tagged based upon the tag input (e.g., the user may tag artwork or a gallery with a tag “looks fun”, which may be shared with other users). In another example, responsive to receiving an add to favorites input associated with the art search result, the art search result may be added to a favorites list associated with the user (e.g., the gallery may be added to a favorite locations list, an artist may be added to a favorite people list, the artwork may be added to a favorite artwork list, etc.). In another example, responsive to a selection of an art search result, the interactive map may be transitioned to an app populated with information contextually relevant to the first art search result (e.g., an art app, a travel app, or other app may be opened). In another example, responsive to a selection of the art search result, the interactive map may be transitioned to a website populated with information contextually relevant to the first art search result (e.g., a gallery homepage). In another example, the interactive map may be populated with a task completion interface comprising task completion functionality. For example, travel planning functionality, purchase art functionality, reserve gallery ticket functionality, post to social network functionality, email functionality, shopping functionality, and/or a variety of other functionality may be facilitated. At 110, the method ends.

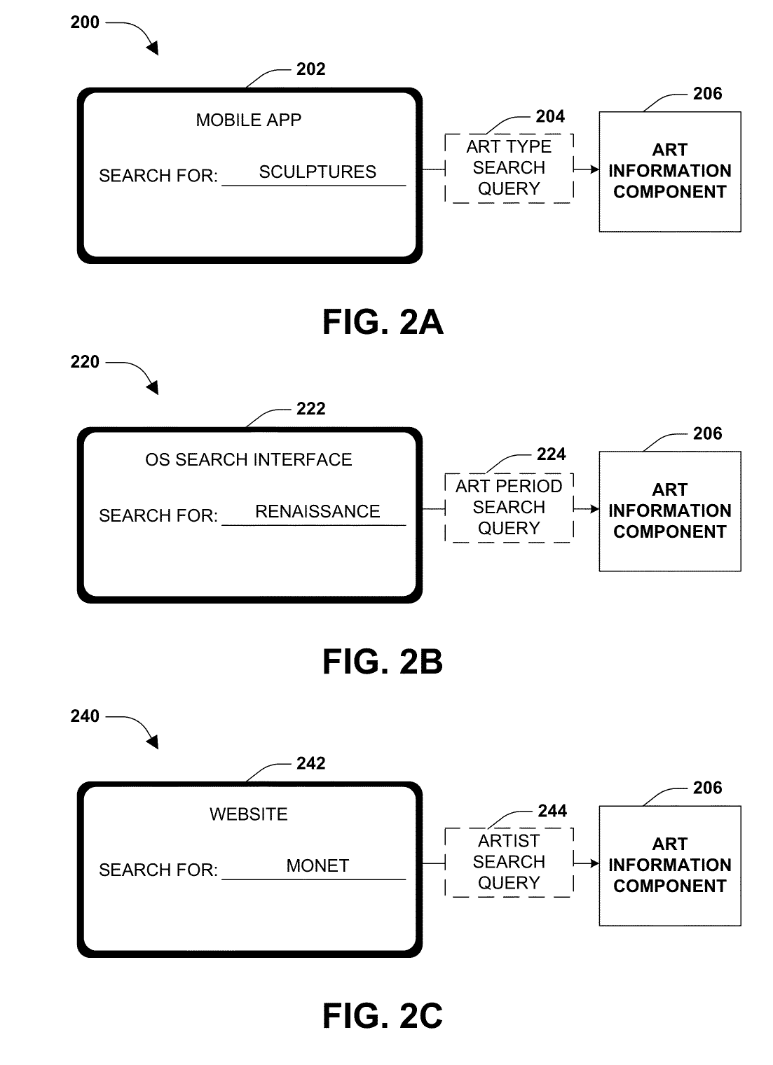

FIG. 2A illustrates an example of a system 200 for receiving an art search query. The system 200 comprises an art information component 206. The art information component 206 may be associated with a mobile app 202 (e.g., the art information component 206 may be hosted on a mobile device comprising the mobile app 202 or may be hosted by a remote server accessible to the mobile app 202). In an example, a user may submit an art type search query 204 through the mobile app 202 (e.g., a search query for “sculptures”). The art information component 206 may be configured to receive the art type search query 204, which may be used to populate an interactive map with art search results corresponding to the art type search query 204 (e.g., museums, galleries, and/or other locations of sculptures may be populated within the interactive map).

FIG. 2B illustrates an example of a system 220 for receiving an art search query. The system 220 comprises an art information component 206. The art information component 206 may be associated with a device comprising an operating system search interface 222, such as a search charm (e.g., the art information component 206 may be hosted on a device comprising an operating system that hosts the operating system search interface 222 or may be hosted by a remote server accessible to the device). In an example, a user may submit an art period search query 224 through the operating system search interface 222 (e.g., a search query for “Renaissance”). The art information component 206 may be configured to receive the art period search query 224, which may be used to populate an interactive map with art search results corresponding to the art period search query 224 (e.g., museums, galleries, and/or other locations of Renaissance artwork may be populated within the interactive map).

FIG. 2C illustrates an example of a system 240 for receiving an art search query. The system 240 comprises an art information component 206. The art information component 206 may be associated with a personal computer accessing a website 242 (e.g., the art information component 206 may be hosted by a remote server that hosts the website 242). In an example, a user may submit an artist search query 244 to the website 242 (e.g., a search query for “Monet”). The art information component 206 may be configured to receive the artist search query 244, which may be used to populate an interactive map with art search results corresponding to the artist search query 244 (e.g., museums, galleries, and/or other locations of artwork by Monet may be populated within the interactive map).

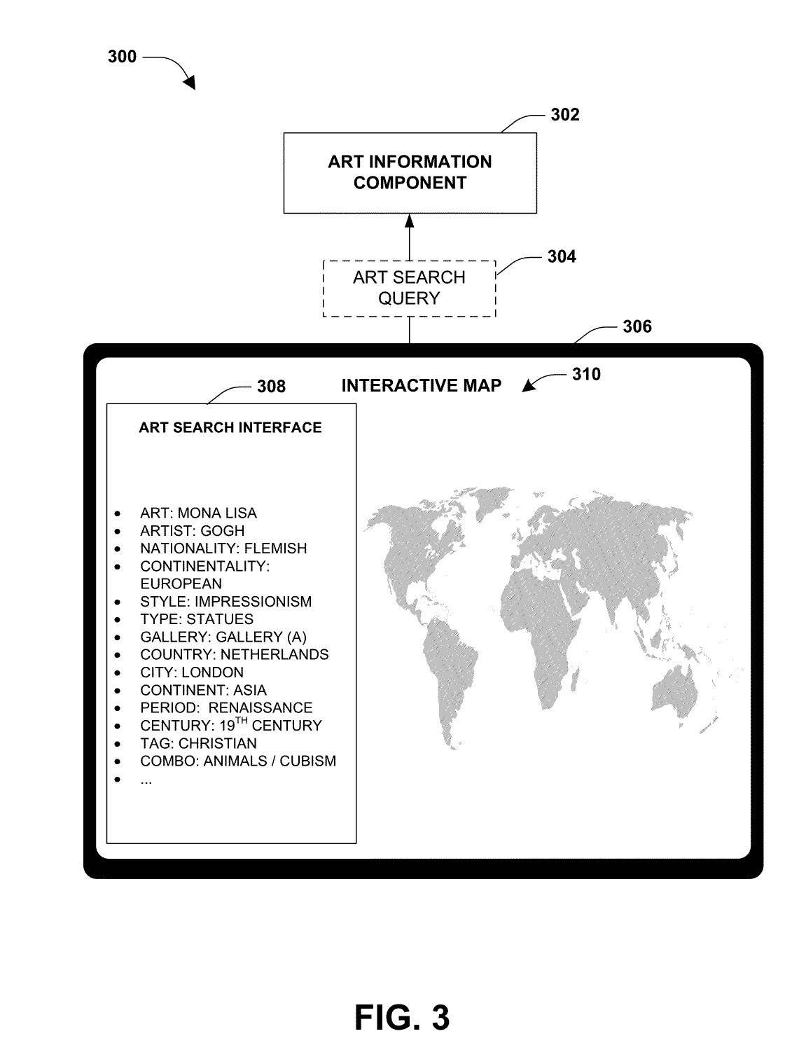

FIG. 3 illustrates an example of a system 300 for receiving an art search query 304. The system 300 may comprise an art information component 302. The art information component 302 may be associated with a device 306 hosting an interactive map 310. The interactive map 310 may be populated with an art search interface 308. The art search interface 308 may expose one or more query categories through which a user may specify search terms (e.g., selected or input by the user). For example, the art search interface 308 may specify an artwork category, an artist category, a nationality category, a continentiality category, an art style category, art gallery category (e.g., a house, a museum, an outdoor location, a building, and/or any other location at which art may be located), a country category, a city category, a continent category, an art period category, a century category, a tag category, and/or a combination of multiple categories. In this way, the art information component 302 may receive the art search query 304 from the art search interface 308.

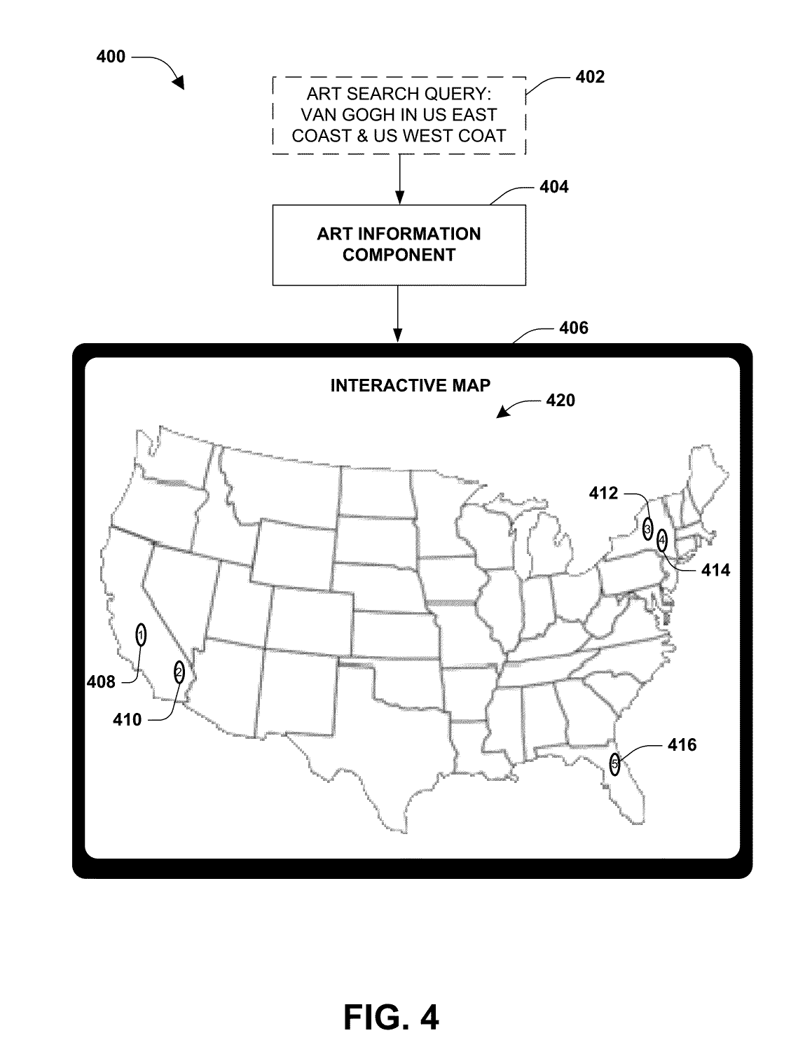

FIG. 4 illustrates an example of a system 400 for populating an interactive map 420 with art search results. The system 400 comprises an art information component 404 (e.g., 206 in FIG. 2A, FIG. 2B and FIG. 2C and/or 302 in FIG. 3). In an example, the art information component 404 may receive an art search query 402, such as a query “Vah Gogh in US East Coast and US West Coast”. The art information component 404 may be configured to identify a set of art search results associated with the art search query 402. For example, the set of art search results may comprise a first search result 408 (e.g., a first location comprising Vah Gogh artwork), a second search result 410 (e.g., a second location comprising Vah Gogh artwork), a third search result 412 (e.g., a third location comprising Vah Gogh artwork), a fourth search result 414 (e.g., a fourth location comprising Vah Gogh artwork), a fifth search result 416 (e.g., a fifth location comprising Vah Gogh art artwork and/or other search results (e.g., locations along the east and west coast of the US at which Van Gogh artwork may be located). The art information component 404 may be configured to populate the interactive map 420 with the set of art search results. The interactive map 420 may be displayed through a device 406. Various functionality and/or interactivity may be supported by the interactive map 420, such as visual navigation within the interactive map 406 (e.g., panning, zooming, etc.), viewing galleries at which Van Gogh artwork is located, refining the art search query 402, viewing imagery and/or descriptive art information associated with the Van Gogh artwork, user tagging of Van Gogh artwork, etc.

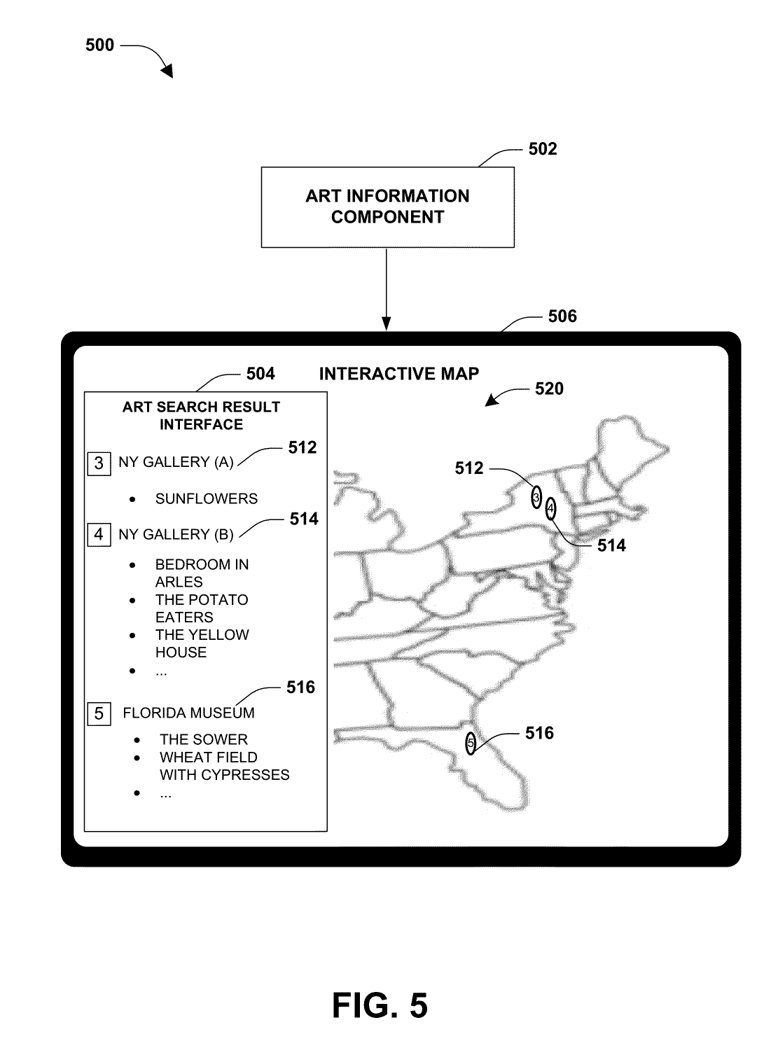

FIG. 5 illustrates an example of a system 500 for populating an interactive map 520 with art search results for display through a device 506. The system 500 comprises an art information component 502 (e.g., 206 in FIG. 2A, FIG. 2B and FIG. 2C, 302 in FIG. 3 and/or 404 in FIG. 4). In an example, the art information component 502 may have populated an interactive map 520 with a set of art search results corresponding to an art search query, such as a query “Vah Gogh in US East Coast and US West Coast” (e.g., FIG. 4). For example, a third search result 512 may correspond to a NY gallery (A) that has Sunflowers artwork by Van Gogh on display. A fourth search result 514 may correspond to a NY Gallery (B) that has Bedroom in Arles artwork, The Potato Eaters artwork, The Yellow House artwork, and/or other artwork by Van Gogh on display. A fifth search results 516 may correspond to a Florida museum that has The Sower artwork, Wheat Field with Cypresses artwork, and/or other artwork by Van Gogh on display.

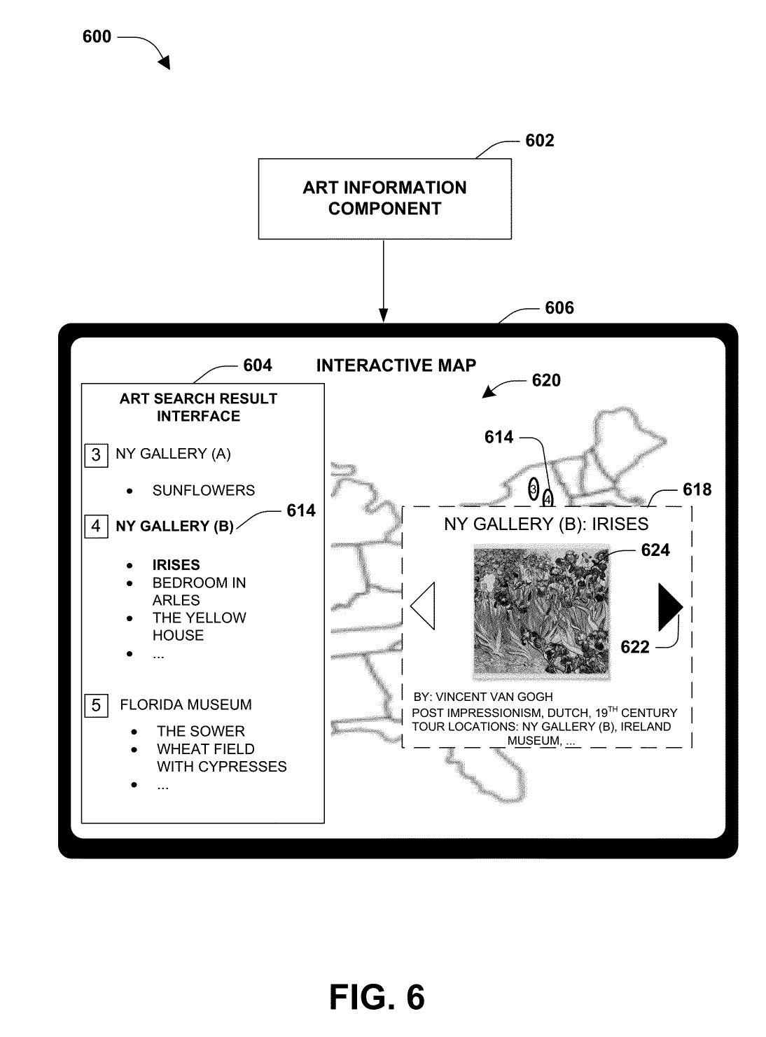

In an example, the art information component 502 may be configured to populate an art search result interface 504, associated with the interactive map 520, based upon the set of art search results. For example, the art information component 502 may organize the set of art search results based upon a hierarchical ordering of organization art categories (e.g., artwork may be organized based upon location, and then by other categories such as date, art type, art style, etc.) to create a hierarchical set of art search results. The art information component 502 may populate the art search result interface 504 based upon the hierarchical set of art search results (e.g., a user may collapse and/or expand art search results and/or organization art categories within the art search result interface 504). In this way, a user may be able to view and/or explore search results through the art search result interface 504 (e.g., responsive to the user selecting an art search result, such as the NY gallery (B) or The Yellow House, an information interface comprising art information associated with the selected art search result may be displayed, as illustrated in FIG. 6).

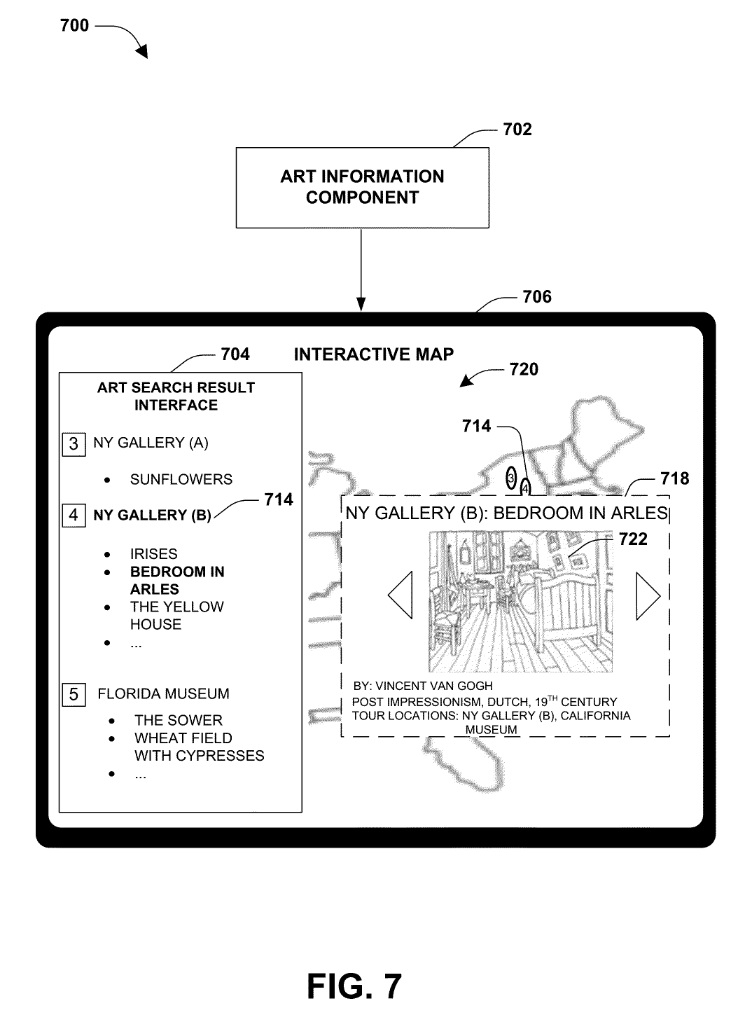

FIG. 6 illustrates an example of a system 600 for displaying an information interface 618 comprising art information displayed through a device 606. The system 600 comprises an art information component 602 (e.g., 206 in FIG. 2A, FIG. 2B and FIG. 2C, 302 in FIG. 3, 404 in FIG. 4 and/or 502 in FIG. 5). In an example, the art information component 602 may have populated an interactive map 620 with a set of art search results corresponding to an art search query (e.g., FIG. 4) and/or may have populated an art search result interface 604 based upon a hierarchical set of art search results (e.g., FIG. 5). The art information component 602 may detect a selection of a fourth search result 614. In an example, a user may have selected the fourth search result 614, such as NY Gallery (B) or the Irises text organized under the NY Gallery (B), within the art search result interface 604. In another example, the user may have selected a map pin within the interactive map 620 that corresponds to the fourth search result 614. Responsive to the selection of the fourth search result 614, the art information component 602 may display the information interface 618 comprising art information associated with the fourth search result 614. For example, the information interface 618 may be populated with an Irises artwork image 624 corresponding to an Irises artwork by Van Gogh that is on display at a NY Gallery (B) (e.g., the art information component 602 may obtain the Irises artwork image 624 utilizing a hyperlink to a remote location comprising the Irises artwork image 624; the art information component 602 may locally store the Irises artwork image 624; etc.). The information interface 618 may be populated with artist information, art period information, country information, century information, gallery information, tour locations, etc. In an example, the information interface 618 may be populated with a plurality of art interfaces corresponding to artwork maintained by the NY Gallery (B) 614. The user may utilize navigation input (e.g., selecting a Next Button 622) to visually navigate between the art interfaces (e.g., FIG. 7).

FIG. 7 illustrates an example of a system 700 for facilitating visual navigation between artwork of a gallery displayed through a device 706. The system 700 comprises an art information component 702 (e.g., 206 in FIG. 2A, FIG. 2B and FIG. 2C, 302 in FIG. 3, 404 in FIG. 4, 502 in FIG. 5 and/or 602 in FIG. 6). In an example, the art information component 702 may have populated an interactive map 720 with a set of art search results (e.g., FIG. 4) and an information interface 718 (e.g., FIG. 6) and/or may have populated an art search result interface 704 based upon a hierarchical set of art search results (e.g., FIG. 5). In an example, the art information component 702 may have populated the information interface 718 with art information associated with a fourth search result 714. For example, the art information component 702 may have populated the information interface 718 with a plurality of art interfaces, such as an art interface populated with an Irises artwork image corresponding to Irises artwork by Van Gogh that is on display at a NY Gallery (B) (e.g., FIG. 6). Responsive to receiving navigation input associated with the information interface 718, the information interface 718 may be transitioned to a second art interface populated with a Bedroom in Arles artwork image 722 corresponding to a Bedroom in Arles artwork by Van Gogh that is on display at a NY Gallery (B). The second art interface may be populated with art information about Van Gogh, the NY Gallery (B), and/or the Bedroom in Arles artwork.

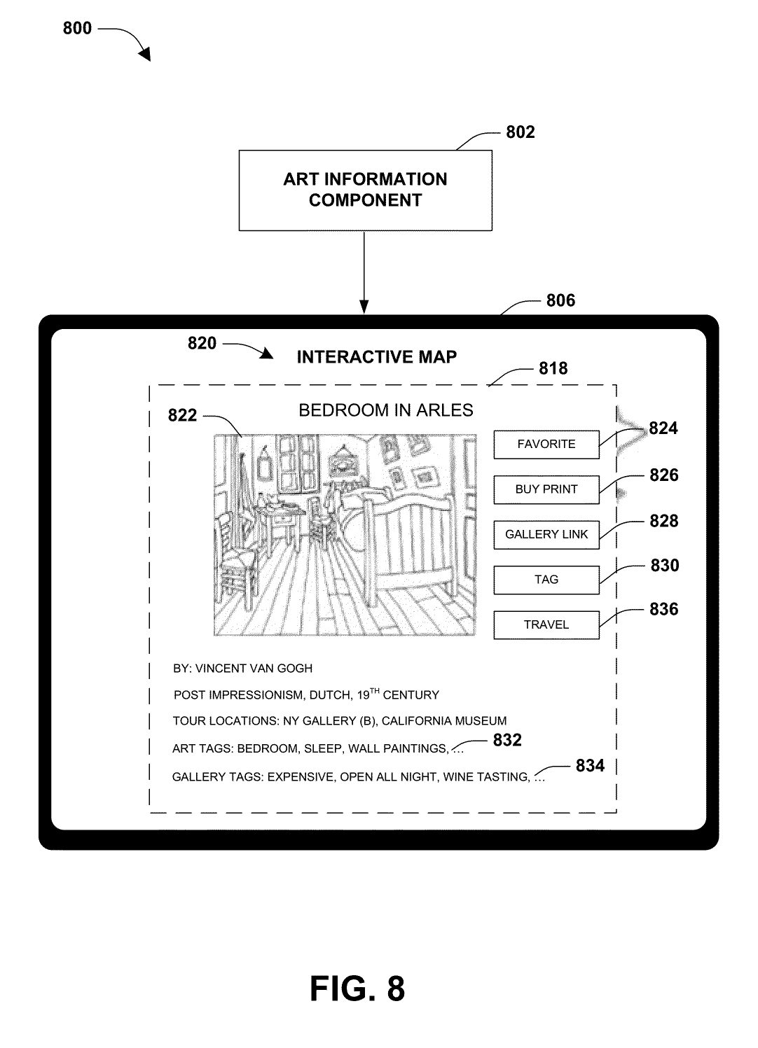

FIG. 8 illustrates an example of a system 800 for displaying an information interface 818 comprising art information for display through a device 806. The system 800 comprises an art information component 802 (e.g., 206 in FIG. 2A, FIG. 2B and FIG. 2C, 302 in FIG. 3, 404 in FIG. 4, 502 in FIG. 5, 602 in FIG. 6 and/or 702 in FIG. 7). In an example, the art information component 802 may have populated an interactive map 820 with a set of art search results corresponding to an art search query (e.g., FIG. 4). The set of search results may comprise a Bedroom in Arles artwork search result. Responsive to selection of the Bedroom in Arles artwork search result, the information interface 818 may be displayed and populated with art information associated with the Bedroom in Arles artwork search result. For example, the information interface 818 may be populated with a Bedroom in Arles artwork image 822 corresponding to a Bedroom in Arles artwork by Van Gogh that is on display at a NY Gallery (B). The art interface 818 may be populated with art information about Van Gogh, information about the NY Gallery (B), art tags 832 (e.g., users may have tagged the Bedroom in Arles artwork with descriptive tags such as a bedroom tag, a sleep tag, a wall paintings tag, etc.), gallery tags 834 (e.g., users may have tagged the NY Gallery (B) with descriptive tags such as an expensive tag, an open all night tag, a wine tasting tag, etc.), and/or the Bedroom in Arles artwork.

The interactive map 820, such as the art interface 818, may be populated with a task completion interface comprising task completion functionality. In an example, an add to favorites input may be received through a favorite interface 824 (e.g., the Bedroom in Arles artwork and/or the NY Gallery (B) may be added to a favorites list associated with the user). In another example, a purchase art input may be received through a shopping interface 826 (e.g., the user may be directed to a website and/or app through which the user may buy prints of the Bedroom in Arles artwork). In another example, a view gallery input may be received through a gallery interface 828 (e.g., the user may be directed to a website, an app, and/or a social network profile associated with the NY Gallery (B)). In another example, a tag input may be received through a tagging interface 830 (e.g., the user may select or specify a tag with which to tag the Bedroom in Arles artwork and/or the NY Gallery (B), which may be shared with other users). In another example, a travel planning input may be received through the travel interface 836 (e.g., the user may be directed to a website and/or an app through which the user may plan a trip to the NY Gallery (B)). In this way, travel planning functionality, purchase art functionality, reserve gallery tickets functionality, post to social network functionality, email functionality (e.g., share art information with a user), shopping functionality, and/or a variety of other task completion functionality may be performed through the task completion interface.

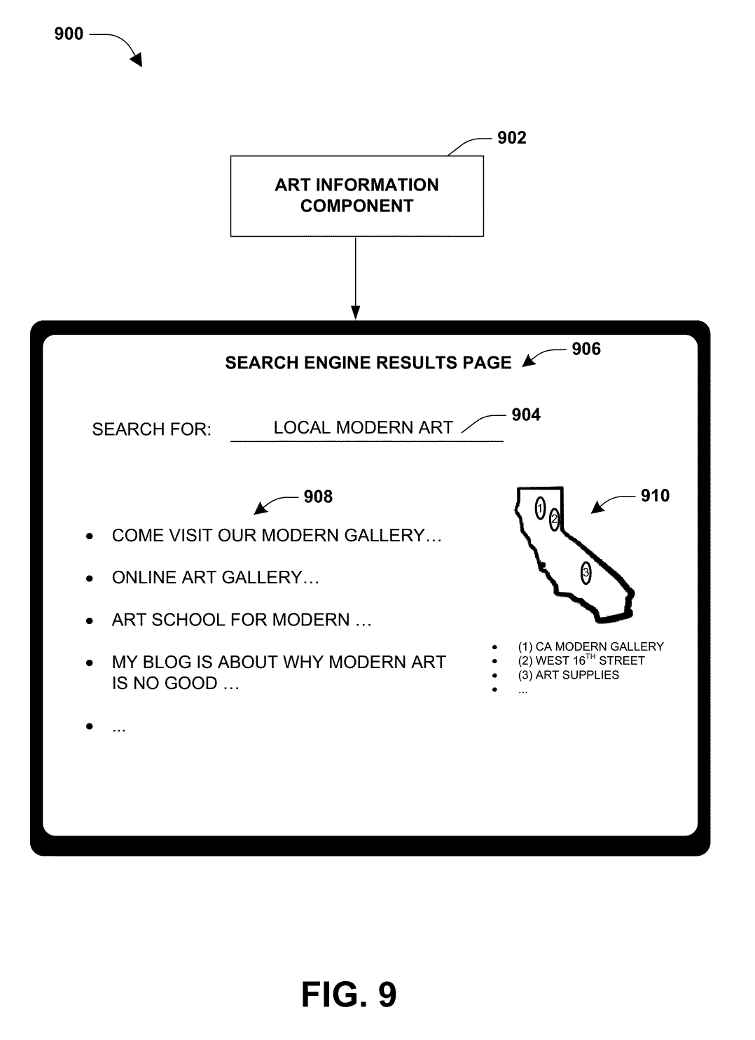

FIG. 9 illustrates an example of a system 900 for embedding an interactive map 910, populated with a set of art search results, within a search engine results page 906. The system 900 comprises an art information component 902 (e.g., 206 in FIG. 2A, FIG. 2B and FIG. 2C, 302 in FIG. 3, 404 in FIG. 4, 502 in FIG. 5, 602 in FIG. 6, 702 in FIG. 7 and/or 802 in FIG. 8). For example, the art information component 902 may be associated with a search engine that may have received a search query “local modern art” 904 through a search website hosted by the search engine. The search engine may generate search results 908 corresponding to the search query “local modern art” 904. The art information component 902 may be configured to identify the set of art search results based upon the search query “local modern art” 904, such as a first search result (e.g., a California Modern Gallery), a second search result (e.g., a West 16^{th} Street at which a modern statue is located), a third search result (e.g., an art supplies store), etc. The set of art search results may be used to populate an interactive map 910. The interactive map 910 and/or the set of art search results may be embedded into the search engine results page 906 comprising the search results 908. The search engine results page 906 may be provided to a user.

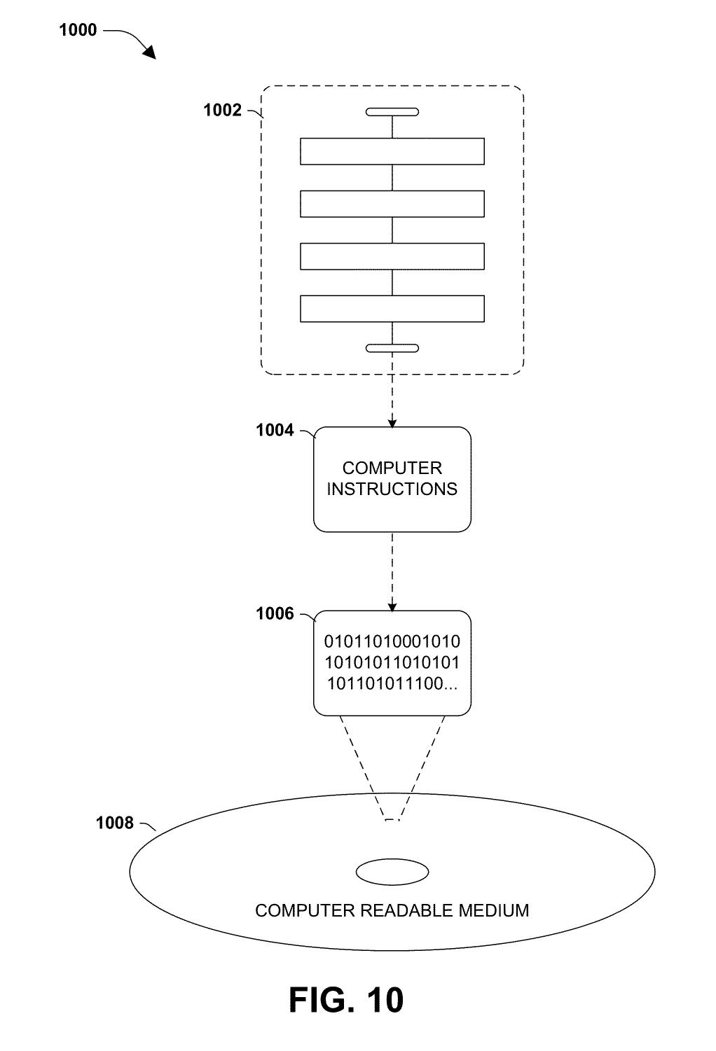

Still another embodiment involves a computer-readable medium comprising processor-executable instructions configured to implement one or more of the techniques presented herein. An example embodiment of a computer-readable medium or a computer-readable device is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 100 of FIG. 1, for example. In some embodiments, the processor-executable instructions 1004 are configured to implement a system, such as at least some of the exemplary system 200 of FIG. 2A, at least some of the exemplary system 220 of FIG. 2B, at least some of the exemplary system 240 of FIG. 2C, at least some of the exemplary system 300 of FIG. 3, at least some of the exemplary system 400 of FIG. 4, at least some of the exemplary system 500 of FIG. 5, at least some of the exemplary system 600 of FIG. 6, at least some of the exemplary system 700 of FIG. 7, at least some of the exemplary system 800 of FIG. 8, and/or at least some of the exemplary system 900 of FIG. 9, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

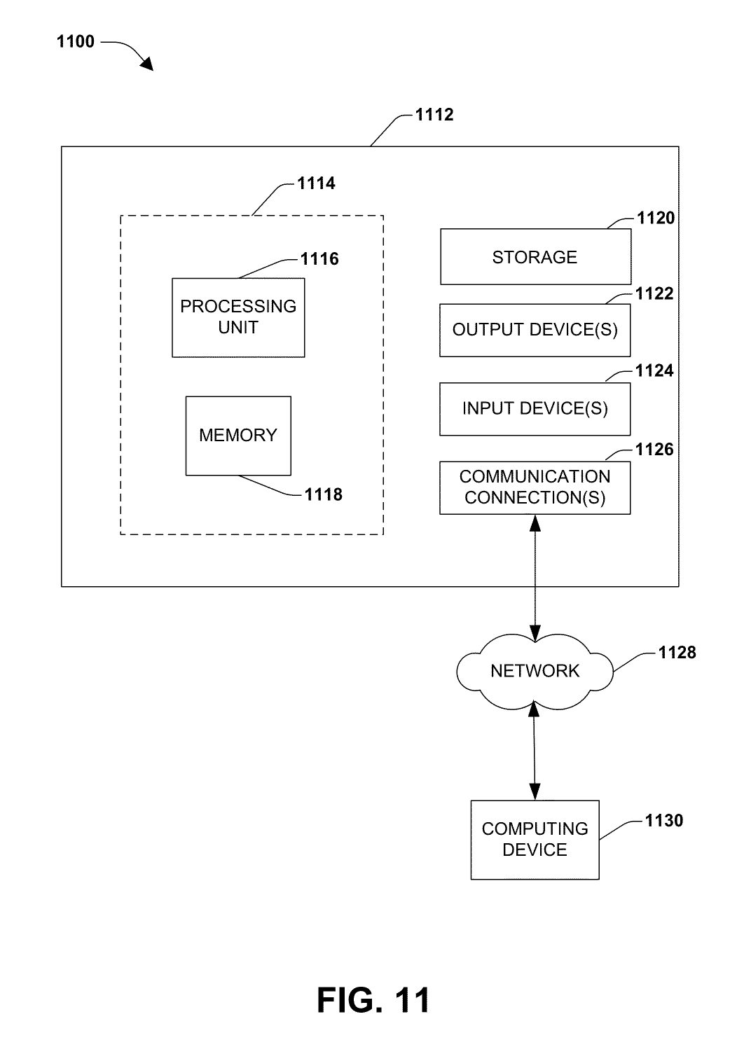

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for populating an interactive map with art search results, comprising:
receiving an art search query;
identifying a set of art search results associated with the art search query; and
populating an interactive map with the set of art search results.

2. The method of claim 1, the art search query comprising at least one of an artist name, a gallery name, an art style, an artwork name, an artist nationality, an art type, a geographical location, an art period, a century, a tag, or a combination one or more query categories.

3. The method of claim 1, the art search query received through at least one of an operating system search interface, an entity summary interface, a search website, a social network search interface, a map app, a travel app, or an art app.

4. The method of claim 1, comprising:
displaying the interactive map through at least one of an app, a website, a search engine results page, an mobile alert, or an operating system search interface.

5. The method of claim 1, comprising:
populating an art search result interface associated with the interactive map based upon the set of art search results.

6. The method of claim 5, the populating an art search result interface comprising:
organizing the set of art search results based upon a hierarchical ordering of organization art categories to create a hierarchical set of art search results; and
populating the art search result interface with the hierarchical set of art search results.

7. The method of claim 5, comprising:
displaying an organization art category through the art search result interface; and
responsive to a selection of the organization art category, displaying one or more art search results, of the set of art search results, corresponding to the organization art category.

8. The method of claim 1, comprising:
responsive to a selection of a first art search result within the interactive map, displaying an information interface comprising first art information associated with the first art search result.

9. The method of claim 8, the first art information comprising at least one of an image of an art gallery, an image of artwork, an image of an artist, a gallery description, an art style, an art type, an art period, a century, a tag, geographical information, or an artist description.

10. The method of claim 8, the first art search result corresponding to a gallery, and the method comprising:
populating the information interface with a plurality of art interfaces corresponding to artwork maintained by the gallery; and
facilitating visual navigation between respective art interfaces.

11. The method of claim 1, comprising:
responsive to receiving a tag input associated with a first art search result, tagging the first art search result based upon the tag input.

12. The method of claim 1, comprising:
responsive to receiving an add to favorites input associated with a first art search result, adding the first art search result to a favorites list associated with a user.

13. The method of claim 1, comprising:
responsive to a selection of a first art search result, transitioning to an app populated with information contextually relevant to the first art search result.

14. The method of claim 1, comprising:
responsive to a selection of a first art search result, transitioning to a website populated with information contextually relevant to the first art search result.

15. The method of claim 1, comprising:
embedding the interactive map within a search engine results page.

16. The method of claim 1, comprising:
populating the interactive map with a task completion interface comprising task completion functionality.

17. The method of claim 16, the task completion functionality comprising at least one of travel planning functionality, purchase art functionality, reserve gallery tickets functionality, post to social network functionality, email functionality, or shopping functionality.

18. A system for populating an interactive map with art search results, comprising:
an art information component configured to:
receive an art search query;
identify a set of art search results associated with the art search query; and
populate an interactive map with the set of art search results.

19. The system of claim 18, the art information component configured to:
populate an art search result interface associated with the interactive map based upon the set of art search results.

20. A computer readable medium comprising instructions which when executed perform a method for populating an interactive map with art search results, comprising:
receiving an art search query;
identifying a set of art search results associated with the art search query; and
populating an interactive map with the set of art search results.
